(19) United States
(12) Patent Application Publication
(10) Pub. No.: US 2026/0102317 A1
(43) Pub. Date: Apr. 16, 2026

(54) ALL PLASTIC CANNULA

(71) Applicant: INTERTECH PLASTICS LLC, Denver, CO (US)

(72) Inventor: Simon C. Knight, Brigend (GB)

(21) Appl. No.: 19/357,584

(22) Filed: Oct. 14, 2025

Related U.S. Application Data
(60) Provisional application No. 63/706,918, filed on Oct. 14, 2024.

(51) Int. Cl. A61J 1/20; A61J 1/14

(52) U.S. Cl. CPC A61J 1/2065; A61J 1/1412; A61J 1/2051; A61J 1/2096

(57) ABSTRACT

A dispensing system is formed entirely from plastic materials. The system allows for the closed loop transfer of fluid from a vial to a syringe relying a diaphragm that is captured between a frame and a connector element. The connector element includes a bellows sleeve with a resilient top panel that is penetrated by a cannula and/or needle when fluid is withdrawn, whereas the diaphragm may expand or contract in response to pressure differentials created as the fluid is transferred.

### CROSS REFERENCE TO RELATED APPLICATIONS

This application claims priority to United States provisional patent application Ser. No. 63/706,918 filed on Oct. 14, 2024, which is incorporated by reference herein.

### TECHNICAL FIELD

The present invention relates to an apparatus and system for the safe handling of potentially dangerous substances and, more specifically, to non-metallic cannula and attachment system that allows for the transfer and dispensing of substances without exposing the handler to direct contact with that substance.

### BACKGROUND

Particularly in the medical and manufacturing fields, fluids need to be measured and dispensed as accurately and efficiently as possible, especially to the extent these fluids tend to be volatile and/or toxic. Thus, numerous “closed loop” systems have been proposed to avoid loss of the fluid due to leakage and exposure to the ambient environment.

United States patent nos. 10,276,654; 10,456,329; 10,744,315; 11,147,740; and 11,147,958 disclose such closed loop systems by relying on transferring fluid from a sealed vial into a syringe. In each case, the syringe is charged and filled without exposing the fluid in the vial to the ambient environment. Equally important, these systems insure that anyone handling the vial and syringe also never directly contacts with the fluid (as might otherwise occur in an open system reliant on pouring or pipette transfer). These disclosures are incorporated by reference herein.

One disadvantage to the aforementioned patented systems is that they often rely on high cost and/or difficult to manufacture metallic components. A system made entirely from plastic, as well as one that has lower manufacturing costs, would both be welcomed.

Another significant consideration is the development of a versatile system in which disposable elements (e.g., those surfaces/components that might be directly exposed to the fluid) are designed to minimize waste while still allowing for the use of standardized replaceable elements. Here again, the use of plastic or lower cost, mass-produced materials, particularly in the disposable elements, would facilitate these goals.

### SUMMARY OF INVENTION

A closed loop system manufactured entirely from non-metallic components is contemplated. In its most basic form, the system includes a rigid fitment that attaches to the fluid vial. The fitment includes a frame that receives a snap-in connector, with an expandable diaphragm captured therebetween. A bellows-like sleeve is also disposed between the frame and the connector. A piercing cannula may be coupled to a transfer implement, such as a syringe, or coaxially inserted into the fitment adjacent to the sleeve immediately before use.

This arrangement enables the fitment to be coupled to the fluid vial for as long as fluid needs to be dispensed from that vial. In contract, the use of different cannula and syringes allows for multiple dispensing events, whereas the sleeve and diaphragm expand and contract to accommodate pressure changes without ever allowing the air in the vial/fitment to come into contact with the ambient environment.

In some aspects, the system includes sealing assembly, including a plug held in place by a snap-on cap, that can be seated on the neck opening of the vial (preferably during the initial filling of the vial). Separately, the syringe element can include a needle that pierces both the cannula element and the top panel of the sleeve in order to contact the fluid in the vial.

All elements of the system are made from polymeric and/or non-metallic materials to minimize costs and simplify manufacture. In some aspects, the fitment is made from appropriate thermoplastics that can be molded, whereas the sleeve and diaphragm are made from rubber, silicon, or other similar materials.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the invention may be better understood by reference to the detailed description taken in connection with the following illustrations. These appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure.

In the drawings and attachments, all of which are incorporated as part of this disclosure:

FIG. 1A is a three dimensional perspective view of the system, including the syringe, the fitment/diaphragm, and the fluid-containing vial, whereas FIG. 1B is a comparable view but with the diaphragm omitted so as to allow for greater visibility of the sleeve and connector contained within the frame.

FIG. 2A is a diametric cross sectional perspective view of FIG. 1B, with FIG. 2B showing a cross sectional side view of the callout box shown in FIG. 2A.

FIG. 3 is a perspective view of the syringe element.

FIG. 4 is a exploded perspective view of the vial and sealing assembly.

FIG. 5A is a three dimensional perspective view of the fitment, whereas FIG. 5B a corresponding, diametric cross sectional perspective view.

FIG. 6 is a three dimensional perspective view of the rigid frame of the fitment of FIG. 5A shown in isolation.

FIG. 7 is a three dimensional perspective view of the connector and sleeve of the fitment of FIG. 5A shown in isolation.

FIG. 8A is an exploded three dimensional perspective view of the sleeve, cannula, and connector shown in isolation, while FIG. 9B is a corresponding, diametric cross sectional side view.

FIG. 9 is a schematic diametric cross sectional view of the rigid frame attached to the vial and sealing assembly, illustrating how the diaphragm may expand within and through the openings of the rigid frame.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

References to horizontal and vertical are relative to the drawings and, more specifically, the expectation that industrial drums and containers typically provide an opening along a top facing. Generally, references to coupling or attachment in this disclosure are to be understood as encompassing any of the conventional means used in this field, such as by way of of snap- or force fitting of components, threaded connections, bead-and-groove, and slot-and-flange assemblies and the like. Similarly, the term engagement may involve coupling or an abutting relationships, depending upon the context. Finally, to the extent the containers used in these systems tend to have cylindrical and/or cup-like shape, the height will align in an axial plane whereas the width extends radially and perpendicular to the height. All of these terms should be considered in the context in which it is used, and any perceived ambiguity can potentially be resolved by referring to the drawings, the description, and the general understanding and expectations in this field.

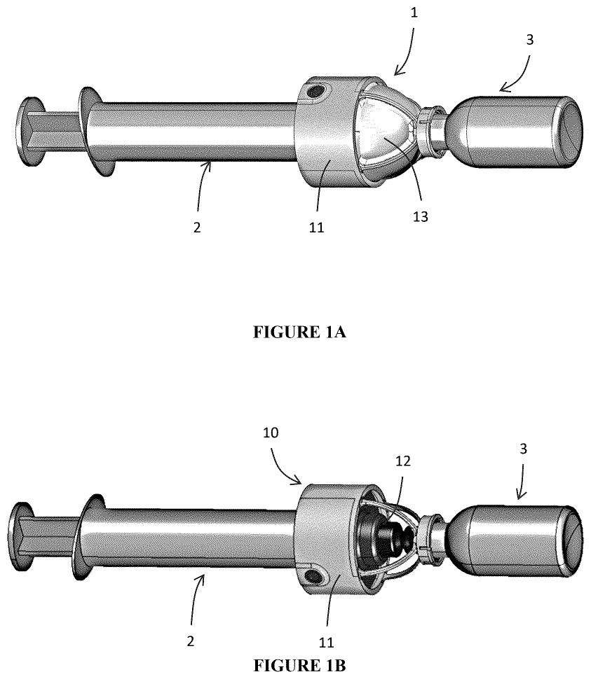

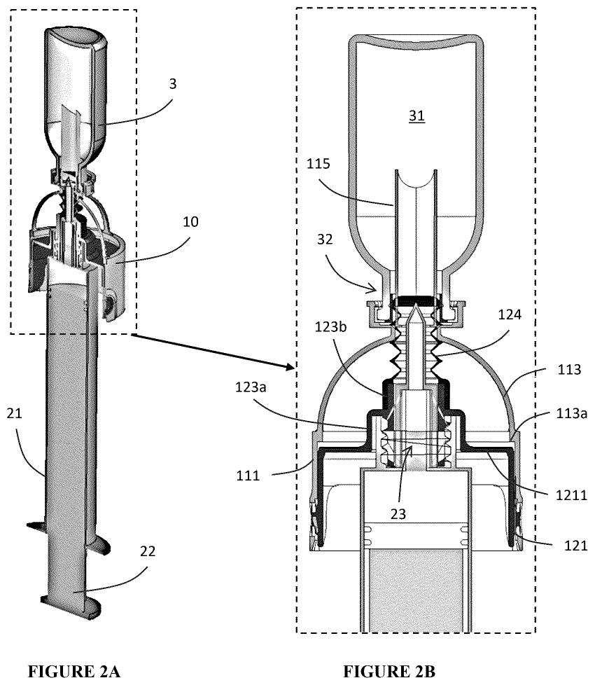

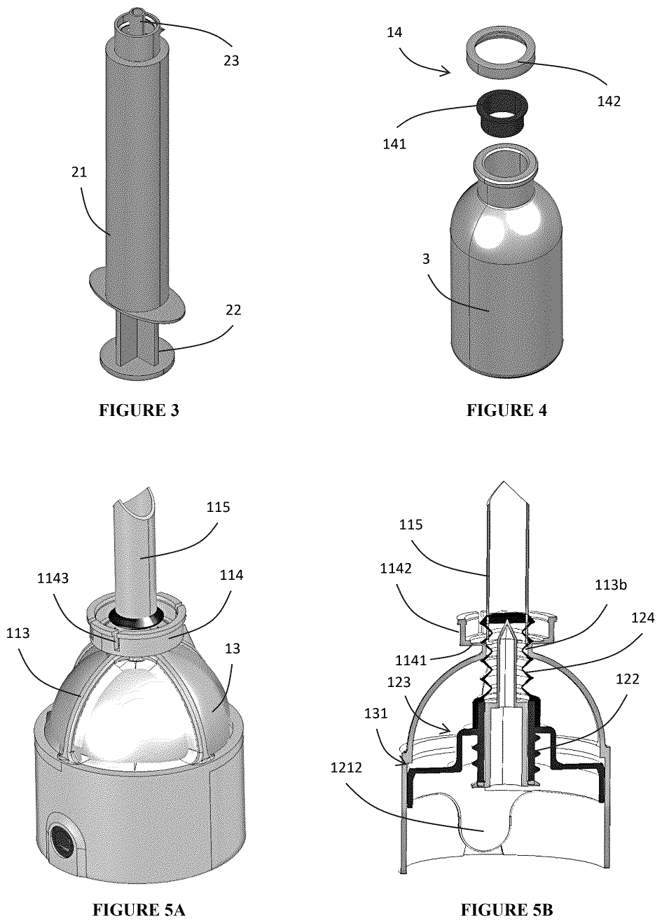

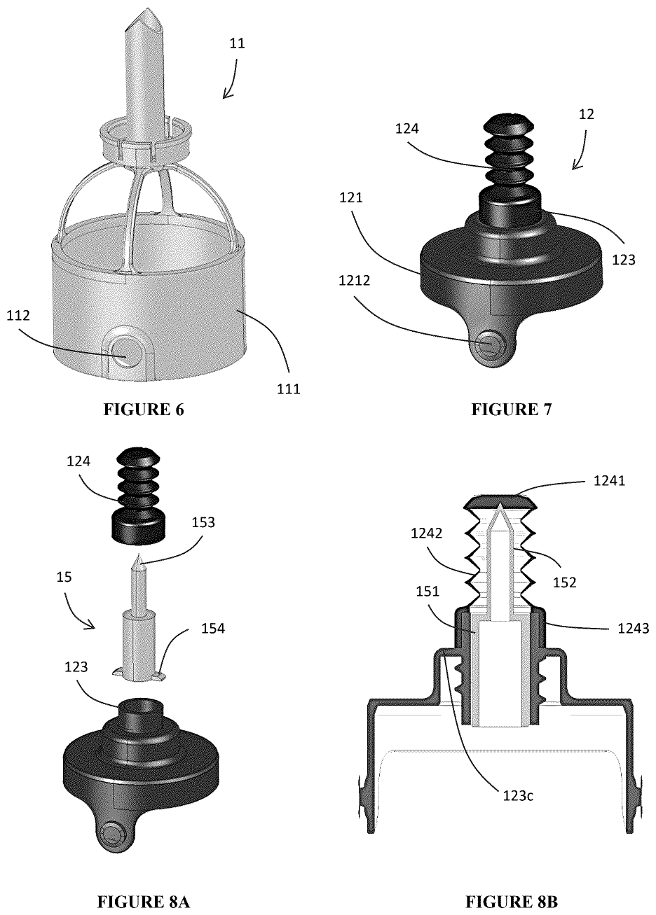

With reference to FIGS. 1 through 9, the closed loop dispensing system 1 couples to a syringe 2 and fluid-containing vial 3 at its opposing ends. The system 1 includes a rigid fitment or hub 10 including a rigid frame 11 and a connector element 12, with a diaphragm 13 captured and held between these elements so that it may expand or contract in response to pressure variations within the system 1, particularly as fluids enter/exit the interior volume 31 of the vial 3.

In some aspects, the diaphragm 13 has a hemispheric or frustoconical shape that conforms to the inner diameter and/or contours of the frame 11, as described below. The diaphragm is made from an easily formed elastomeric material, including but not limited to natural, silicone, butyl rubber, styrene butadiene, or polyurethane rubbers and the like. In some aspects, the diaphragm 13 is symmetric about the central axis defined by the system 1, syringe 2, and vial 3 so as to insure uniform expansion and contraction in a manner that minimizes localized areas of stress and strain.

The frame 11 consists of several features. On its syringe-adjacent side, a tubular base 111 includes coupling features, such as apertures 112, that cooperate with corresponding features on the connector 12 (as will be described below). The inner diameter of the base 111 is configured to coaxially receive the connector along its outer-most diameter, with an axial offset 131 allowing for the terminal edge of the diaphragm to be captured and restrained between the frame 11 and the connector 12 to form an air-tight, interior volume 132.

A plurality of support arms 113 extend axially away from the base 111 and converge on a closure cap 114. The arms 113 are spaced apart from one another so as define gaps that accommodate expansion of the diaphragm 13 during use of the system 1. The arms 113 may be curved (as shown), straight, or curvilinear. In some aspects 2, 3, 4, or 5 arms 113 are spaced out uniformly around the top edge of the base 111 and converge with the closure cap 114. The arms 113 include a radial step 113a to better define the offset 131 at the bottom edge of the frame 11. Conversely, the arms 113 may include an axial extension 113b at the top edge, with the inner dimensions (e.g., diameter and axial height) configured to accommodate and retain the top end of the diaphragm 13.

The closure cap 114 defines a central aperture, with a radial flange 1141 extending away from and a coupling skirt 1142 extending axially therefrom. The upper most edge of the skirt 1142 may include a retention feature, such as a lip or a ramp, with an inner diameter selected to couple and remain affixed to the opening of the vial 3. In some aspects, one or a series of axially slots 1143 can be formed in the skirt 1142 to facilitate snap-fitting onto the vial 3.

A trocar element 115 is positioned coaxially within the skirt 1142. The trocar element 115 extends above the upper most edge of the skirt 1142 and serves to extend and further define the aperture formed in the closure cap 114. The trocar element 115 includes a piercing edge that can penetrate any protect film or seal that might be provided on the opening of the vial 3, while its outer diameter is sized to conform to and seal the vial 3. In other aspects, the outer diameter of the trocar element 115 conforms to and seal a sealing assembly 14 (described below), which is received on/coupled to the opening of the vial 3. An inner lumen of the trocar element 115 possesses an inner diameter sufficient to accommodate and coaxially receive features on the connector element 12, such as the bellows sleeve 124 and/or the cannula 15.

Notably, base 111, arms 113, closure cap 114, and trocar element 115 are integrally formed as a single and contiguous member (e.g., via a molding process). This construction of the frame 11 insures the physical integrity and sealing capability of the fitment 10 (when fully assembled) so as to create the closed loop system. These components are preferably formed from one or a selection of compatible thermoplastic materials selected on the basis of cost, durability, and workability.

The connector 12 has a cup-like shape formed around a central aperture that is dimensioned to accommodate the syringe 2 and cannula 15. The basic features of the connector 12 include an outer coupling skirt 121, an inner coupling skirt 122, a sleeve mounting extension 123, and a bellows sleeve 124. While elements 121, 122, and 123 are integrally formed as a single and contiguous member (e.g., via a molding process), the sleeve 124 can be formed via a two shot molding process or it can be separately manufactured and fitted onto the mounting extension 123 prior to coupling the connector to the frame 11 (and capturing the diaphragm 13 therebetween). While the bellows sleeve 124 is preferably formed from an elastomeric material (similar or identical to those identified as being appropriate for the diaphragm 13), the remaining elements of the connector can be formed from one or a selection of compatible thermoplastic materials selected on the basis of cost, durability, and workability. In some aspects, the thermoplastics of the frame 11 and connector 12 will be identical, and may include polyolefins or other resins commonly used in consumer or medical-grade products.

The outer coupling skirt 121 is dimensioned to be coaxially received within the base 111 of the frame 11. Coupling feature 1212 may take the form of bayonet-style tabs that conform with apertures 112 to insure the frame 11 and the connector 12 remain affixed. Additional features, such as bead and groove, threads, or other known connections can also be employed. The inner diameter of the skirt 121 is configured to received the syringe 2.

To that end, an inner coupling skirt 122 extends coaxially downward (i.e., in the same direction) as the skirt 121, with a radial flange 1211 connecting the skirt 121 to other features of the connector 12. The inner and/or outer facings of the inner skirt 122 may include features to form a secure but releasable connection with the syringe 2, such as threads, slot and flange rotation, etc.. In this manner, it will be understood that the syringe must also possess corresponding features.

The mounting extension 123 extends from the opposite facing of the flange 1211 (relative to the sidewalls constituting skirt 121). In some aspects, the extension 123 will include a pair of cylindrical extensions 123a, 123b, with the inner skirt 122 actually connecting to the flange 123c creating offset between extensions 123a, 123b. The inner facings of the skirt 122 and extension 123 define the central aperture of the connector 12, and these facings will contact and guide the cannula 15.

The bellows-like sleeve 124 is formed or fitted onto the extension 123. The sleeve 124 includes a flat top panel 1241 that is capable of being penetrated by the cannula 15 and/or a needle from the syringe 2. Preferably, the material forming panel 1241 is of a consistent thickness, density, and resilience to reseal when the cannula and/or needle is removed, thereby insuring the vial 3 remains sealed and protected from exposure to the ambient environment.

The sleeve 124 is of hollow tubular construction, with pleated, corrugated, or otherwise axially compressible sidewalls 1242. These sidewalls 1242 (along with diaphragm 13) facilitate the pressure equalization functions of the fitment 10. The sidewalls 1242 are expected to have a comparatively thinner construction relative to panel 1241, and selected portions of the sidewalls 1242 may include ribs and/or grooves to help guide the desired biasing effects require by the sleeve 124.

At its lower extremity where coupling to the extension 123 occurs, sleeve 124 has a modified sidewall 1243. In instances where the sleeve is subsequently fitted onto the extension 123, this side wall section 1243 might be radially expanded to establish a secure fit. When two shot or other overmolding techniques are employed, the features of wall section 1243 can be modified or rendered distinct (in comparison to sidewalls 1242 and panel 1241). However, in order to maintain the structural integrity and sealing capabilities of the fitment 10, the sleeve 124 is expected to remain functionally attached to the connector 124.

The diameter of the sleeve 124 may allow it to partially or completely protrude into the inner lumen of the trocar element 115. In one aspect, the top facing of the panel 1241 has a beveled, ramped, or tapering circumference that is dimensioned to engage the inner facing/diameter of the opening defined by the vial 3 or the sealing assembly 14. Owing to the resilient nature of the materials used to construct the sleeve 124, it may experience temporary radial and/or axial compression as the syringe/cannula are introduced and used during the operations described herein, with the material and dimensions of the sleeve 124 capable of further facilitating the sealing engagements contemplated herein.

In some aspects, the system 1 may also include a sealing assembly 14. Assembly 14 can be independently coupled to the vial 3 or provided/initially carried on the fitment 10 and, more specifically, on the frame 11 (e.g., over the trocar element 115 and/or within the closure cap 114). The assembly 14 may include one or both of a resilient plug 141 and an overcap 142. Advantageously, the entirety of the assembly 14 can be manufactured independently so as to allow the fitment 10 to be coupled to a variety of different dimensions on the opening of the vial 3. In some aspects, the plug 141 could be inserted into the vial 3 or formed around/fitted onto the frame 11, whereas the overcap 142 is more likely to be seated over the plug 141 in instances where the plug 141 is first attached to the vial. Nevertheless, it is possible to configure the overcap to be carried with the fitment 10/frame 11 and thereafter released or otherwise become affixed to the vial 3.

The plug 141 is configured to cooperate with the sleeve 124 to seal the vial 3 and prevent leakage during dispensing (i.e., charging of the syringe 2). Thus, the plug 141 has an annular shape with the inner diameter sized to coaxially receive the tip of the cannula 15 and/or syringe needle. An axial extension can be imparted to insure the plug 141 maintains good fit in the opening/neck region of the vial 3.

Separately, an overcap element 142 facilitates coupling of the closure cap 114. Specifically, the outer diameter of the overcap 142 will snap-fit or couple with the inner facings of the skirt 1142. Guide members could be formed to fit within/cooperate with slots 1143 to index and orient the vial relative to the fitment 10 (and, by extension, the syringe 2).

The cannula 15 can be formed as an independent component. In operation, the cannula 15 is fitted into the connector 12 or onto the syringe 2. The cannula 15 includes a main body 151 having a wider diameter and generally more rigid construction in comparison to a probe section 152 and penetrating tip 153. Attachment flanges 154 associated with the body 151 provide a means by which the cannula 15 can be coupled to the connector 12 or the syringe 2 (by way of cooperating coupling features). In some aspects, flanges 154 can serve as stops to prevent overextension of the cannula into the vial (i.e., the axial stretching and penetration of the sleeve 124 is limited to minimize wear-and-tear).

The outer diameter of the body 151 will be sized to sealingly and slidingly engage the inner facings of the central aperture of the connector 12 around the entire circumference of the components. In this manner, retraction of the plunger 22 will create sufficient suction to draw fluid from the interior of the vial 31 into the syringe, from which it can be transported and dispensed in a precise/desired dose.

The probe 152 section tapers down to a point at the tip 153 so that the cannula can, in some aspects, penetrate the resilient panel 1241. Accordingly, the tip 153 must allow for an opening (e.g., when the plunger is depressed, so as to create a tear/opening in the tip 153 after the cannula is positioned within the vial 3. Additionally or alternatively, the thinner wall construction of the probe 152 and especially the tip 153 would allow a needle to pass through both the cannula 15 and the sleeve 124 so as to gain temporary access to the interior 31. In either instance, the connector 12 serves to create a barrier to prevent any exposure of the fluid in the vial 3 to the ambient environment.

The dimensions of the cannula 15 relative to the other components of the system will be selected so that the syringe 2 (via the tube 21 and/or plunger 22) must be advanced toward the vial in order to draw fluid from the vial. Thus, the axial length of the probe section 152 is selected to be compatible with the expansion of the bellows sleeve 124 (although the engagement of the panel 1241 with the neck of the vial 3 and/or sealing assembly 14 means that the bellows sleeve 124 does not necessarily need to be fully expanded).

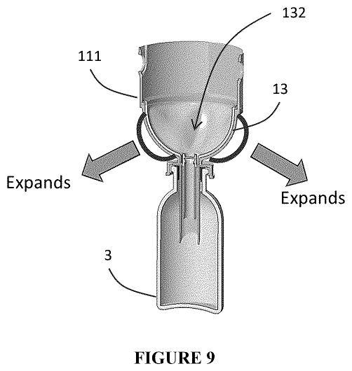

As previously noted and schematically represented in FIG. 9, the diaphragm 13 and bellows in the sleeve 124 are configured to expand and contract in response to the pressure differentials created as the syringe 2 is charged. In the event of any vaporization or leakage of fluid during the charging of the syringe, the vapors and excess fluid will remain contained by the diaphragm.

Thus, the fitment 10 can be coupled to a vial 3 for repeated charging events using different syringes 2 and/or cannula 15 while maintaining a hermetic seal on the vial 3 itself. Once the fluids in the vial 3 are completely drained, the fitment 10 and vial can be disposed of, or the fitment 10 can be decoupled from the vial 3 for further waste processing.

This arrangement provides the added benefit of only requiring change-out of the cannula 15 and/or syringe 2 while maintaining the integrity of the fluid within the vial 3 (assuming the cannula/syringe are sterilized and used within an appropriate time thereafter). In this manner, medical facilities in particular can employ larger volume containers and eliminate the waste associated with single-use vials. Further, the all-plastic nature of the fitment can give rise to the possibility of recycling, whereas previously known systems that employ metallic elements may present greater challenges. Finally, the elimination of metallic components and the use of comparatively low cost elastomers and thermoplastics should reduce costs of the dispensing system.

The syringe 2 may be of any number of designs, but it will typically include an outer tube 21, a plunger 22, and dispensing tip 23. The plunger 22 moves relative to the tube 21 so as to create suction or driving force to push or pull fluids through an opening in the tip 23. An optional needle can be integrally formed or coupled to the syringe 2. When used, this needle would potentially provide a further layer of protection to the extent it could peneratrate a sealed cannula and the sleeve member. Alternatively, an opening or weakened point in the tip of the cannula can be created when the plunger 22 is initially advanced toward the tip 23 so as to allow for fluid to be drawn into the syringe. In all of these arrangements, fluid drawn through the syringe is never exposed to the ambient environment, while the bellows sleeve and diaphragm can expand or contract to accommodate changes in pressure within the vial, syringe, and/or interior void space of the fitment itself.

Similar, the vial 3 need not be of any particular construction, so long as the opening and neck region 32 is configured to accommodate and couple to the fitment. In some aspects, the neck 32 will include a continuous or intermittent series of radial flange(s) to better couple to the sealing assembly 14.

The dispensing system eliminates the need for metallic parts. Instead, all of the components can be formed by molding and/or extrusion techniques. In one aspect, a two shot silicone and tube assembly can be incorporated to manufacture the connector element and sleeve or selected aspects of the sealing assembly. In further aspect, the diaphragm may be captured between or molded as part of one or both of the rigid snap-on frame and the connector assembly. The diaphragm itself is configured to expand and contract so as to push radially outward through the openings in the frame (and/or to retract toward the connector element).

The arrangements contemplated herein allow for an assembly that effectively contains only two parts, thereby simplifying the design and manufacture. Various silicone and rigid polymeric molding and manufacturing techniques eliminate the need for comolding over or onto metallic components. The overall profile (i.e. axial height) of the system can also be reduced, resulting in a reduction in materials use and its associated costs. Still other aspects and advantages can be discerned through careful study of the appended drawings.

All components should be made of materials having sufficient flexibility and structural integrity, as well as a chemically inert nature. The materials should also be selected for workability, cost, and weight. In addition to the materials specifically noted above, common polymers amenable to injection molding, extrusion, or other common forming processes should have particular utility, although metals, alloys, and other composites may be used in place of or in addition to more conventional container and closure materials.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. A dispensing system for closed loop dispensing of fluids, the system comprising:
a fitment with a first facing configured to hermetically seal to an opening in a fluid container and an opposing facing configured to receive a syringe;
wherein the fitment comprises:
a frame having a base section axially separated from a closure cap by a plurality of arms;
a connector having: i) a bellows sleeve engaging an aperture in the closure cap by way of a resilient end panel, ii) an outer skirt configured to be coaxially received within the base section, and iii) an inner skirt configured to releasably couple to the syringe;
a diaphragm positioned between the frame and the connector and configured to contract and/or expand between interstices between the arms in response to pressure differentials within the system; and
a cannula coaxially received within the inner skirt and a portion of the bellows sleeve; and
wherein a central aperture is formed in each of the frame, the connector, and the diaphragm so as to allow for movement of components therethrough.

2. The system of claim 1 wherein the frame and the connector are snap-fitted.

3. The system of claim 1 wherein the fitment is constructed entirely from non-metallic components.

4. The system of claim 3 wherein the non-metallic components consistent of thermoplastics and/or elastomers.

5. The system of claim 1 wherein the frame further comprises a trocar element positioned coaxially within and extending axially out of the closure cup.

6. The system of claim 1 further comprising a sealing assembly engaging the first facing of the fitment.

7. The system of claim 6 wherein the sealing assembly includes at least one of a plug and an overcap.

8. The system of claim 6 wherein the closure cap includes coupling features engaging the sealing assembly.

9. The system of claim 1 wherein the cannula includes attachment flanges positioned on a main body section of the cannula opposite from a probe section.

10. The system of claim 1 wherein at least three arms are spaced apart equally and curve upwardly and radially inwardly to connect to the closure cap.

11. The system of claim 1 wherein the connector includes a mounting extension.

12. The system of claim 1 wherein a tip of the syringe engages the cannula and advances the cannula so as to penetrate the end panel to allow for fluid to be drawn into the syringe, with the interior volume enclosed by the diaphragm preventing leakage or vaporization loss of the fluid to the ambient environment.
